(19) United States
(12) Patent Application Publication
(10) Pub. No.: US 2015/0348081 A1
(43) Pub. Date: Dec. 3, 2015

(54) SYSTEM AND METHOD FOR MANAGING DEPOSIT ACCOUNT REWARDS BASED ON CUSTOMIZABLE PAYMENT CARD TRANSACTION DETAILS

(71) Applicant: My Intershare, LLC, Forney, TX (US)

(72) Inventors: Jeremy VanHoozer, Forney, TX (US); Bruce Allen Smith, Conroe, TX (US)

(21) Appl. No.: 14/723,309

(22) Filed: May 27, 2015

Related U.S. Application Data
(60) Provisional application No. 61/997,276, filed on May 27, 2014.

(51) Int. Cl. G06Q 30/02; G06Q 40/00; G06Q 20/22

(52) U.S. Cl. CPC G06Q 30/0222; G06Q 20/227; G06Q 40/00

(57) ABSTRACT

The present disclosure is related to a method for a reward system. The method includes receiving, at a server, a card processor file containing transaction details for a transaction. The method also includes matching the transaction details to deposit account information to identify a deposit account holder. The method also includes identifying a share beneficiary from the deposit account information. The method also includes determining whether the verification type is a personal identification number (PIN) or a signature. The method also includes issuing a reward amount based on the verification type to the share beneficiary. The method also includes creating a depository file designating the reward amount to the share beneficiary in a format that is importable by a depository financial institution (DFI).

### CROSS-REFERENCE TO RELATED APPLICATION(S) AND CLAIM OF PRIORITY

The present application claims priority to U.S. Provisional Patent Application Ser. No. 61/997,276, filed May 27, 2014, entitled “SYSTEM AND METHOD FOR MANAGING DEPOSIT ACCOUNT REWARDS BASED ON CUSTOMIZABLE PAYMENT CARD TRANSACTION DETAILS,” which is hereby incorporated by reference.

### TECHNICAL FIELD

The present application relates generally to point of sale transaction processing, and more specifically to management and tracking of interchange fees, incomes and rewards associated with card transactions, and associated methods.

### BACKGROUND

Billions of dollars in transactions occur every year through different payment methods. Vendors and businesses pay a small percentage for processing electronic payments on every credit or debit card transaction. The percentage varies depending on different factors such as the merchant service providers and legislation.

### SUMMARY

For a more complete understanding of the present disclosure and its advantages, reference is now made to the following description taken in conjunction with the accompanying drawings, in which like reference numerals represent like parts:

In certain embodiments, a data processing system provides for a reward system. The data processing system includes a processor and an accessible memory. The accessible memory is configured to receive, a card processor file containing transaction details for a transaction, where the transaction details include a verification type. The accessible memory also is configured to match the transaction details to deposit account information to identify a deposit account holder. The accessible memory also is configured to identify a share beneficiary from the deposit account information. The accessible memory also is configured to determine whether the verification type is a personal identification number (PIN) or a signature. The accessible memory also is configured to issue a reward amount based on the verification type to the share beneficiary. The accessible memory also is configured to create a depository file designating the reward amount to the share beneficiary in a format that is importable by a depository financial institution (DFI).

In certain embodiments, a non-transitory computer-readable medium provides for a reward system. The non-transitory computer-readable medium is encoded with executable instructions that, when executed, cause one or more data processing systems to receive, at a server, a card processor file containing transaction details for a transaction, where the transaction details include a verification type. The executable instructions also cause one or more data processing system to match the transaction details to deposit account information to identify a deposit account holder. The executable instructions also cause one or more data processing system to identify a share beneficiary from the deposit account information. The executable instructions also cause one or more data processing system to determine whether the verification type is a personal identification number (PIN) or a signature. The executable instructions also cause one or more data processing system to issue a reward amount based on the verification type to the share beneficiary. The executable instructions also cause one or more data processing system to create a depository file designating the reward amount to the share beneficiary in a format that is importable by a depository financial institution (DFI).

In certain embodiments, a method provides a reward system. The method includes receiving, at a server, a card processor file containing transaction details for a transaction, where the transaction details include a verification type. The method also includes matching the transaction details to deposit account information to identify a deposit account holder. The method also includes identifying a share beneficiary from the deposit account information. In certain embodiments, the share beneficiary is determined by the DFI routing number and DFI account number fields in the ACH file. The DFI identification number identifies the financial institution on incoming transaction files and outgoing ACH reward files. The method also includes determining whether the verification type is a personal identification number (PIN) or a signature. The method also includes issuing a reward amount based on the verification type to the share beneficiary. The method also includes creating a depository file designating the reward amount to the share beneficiary in a format that is importable by a depository financial institution (DFI).

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an implementation of an interchange fee income and reward system according to various embodiments of the present disclosure;

FIG. 2 illustrates an acquisition of deposit account and deposit account holder's information according to various embodiments of the present disclosure;

FIG. 3 illustrates creating a reward program according to various embodiments of the present disclosure;

FIG. 4 illustrates methods for the assignment or enrollment of a reward program according to various embodiments of the present disclosure;

FIG. 5 illustrates potential reward recipients according to various embodiments of the present disclosure;

FIG. 6 illustrates acquisition of card transaction information according to various embodiments of the present disclosure;

FIG. 7 illustrates a method of analysis and calculation based on reward program parameters according to various embodiments of the present disclosure;

FIG. 8 illustrates an analysis and calculation of the reward amount based on reward program parameters according to various embodiments of the present disclosure;

FIG. 9 illustrates creation of the transaction or ACH file for posting reward amounts according to various embodiments of the present disclosure;

FIG. 10 and FIG. 11 illustrate potential database schema methods according to various embodiments of the present disclosure; and

FIG. 12 illustrates an example computing device 100 for n-level replication of supplemental content according to various embodiments of the present disclosure.

### DETAILED DESCRIPTION

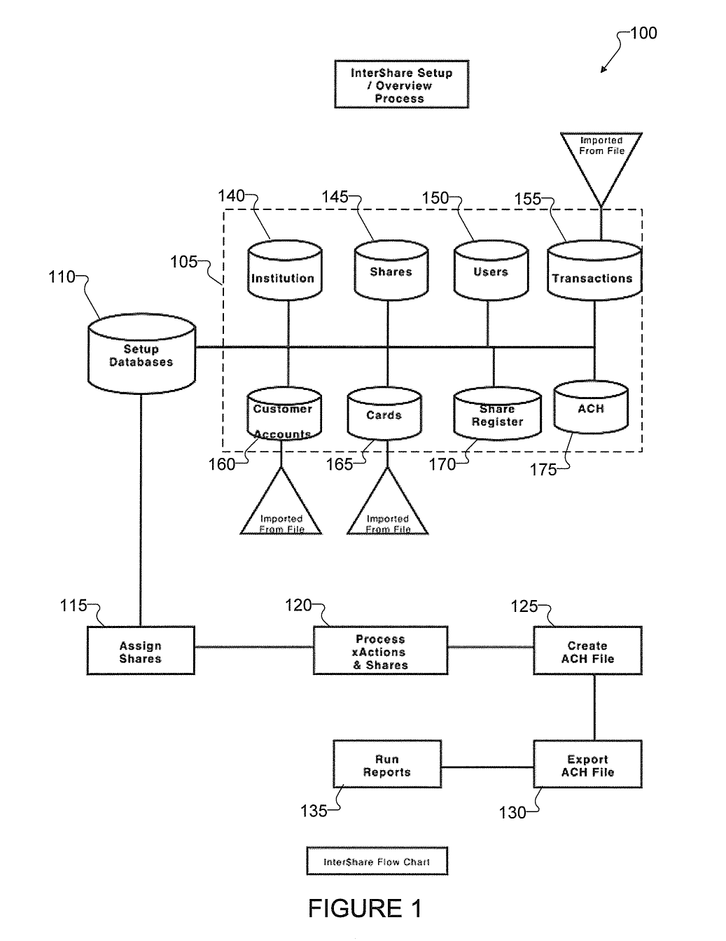

FIGS. 1 through 12, discussed below, and the various embodiments used to describe the principles of the present disclosure are by way of illustration only and should not be construed in any way to limit the scope of the disclosure. Those skilled in the art understand that these principles may be implemented in any type of suitably arranged device or system.

It is desirable to have a data processing system and method for monitoring, recording, and modifying information relating to financial institution payment cards, interchange fees, incomes, and reward programs in general. It is preferable for such a system to be able to perform these functions without the financial institution having to apply for additional bank identification numbers and even more preferable to be able to use the current cards issued to the deposit account holders. It would further be desirable to have a system and method capable of making the calculations necessary for assisting financial institutions in managing deposit account reward programs based on interchange fees and incomes with regard to specified transaction details. More specifically, it would be advantageous to have a system and method for gathering data from external sources such as card network providers, core processing systems, and other configurable sources and then utilizing this information along with user specified reward program information to automatically make calculations such as a monetary reward for the use of signature based transactions, and programmatically crediting or debiting the corresponding internal or external deposit accounts. Due to compliance standards, the system decrypts the received transaction information for processing and storing. After processing and storing, the system encrypts a transaction file to transmit to a depository financial institution (DFI). It would also be desirable to have a system automatically generate the necessary reports for the financial institution to reconcile the reward programs with their accounting systems.

The present disclosure advantageously fills the aforementioned deficiencies by providing an interface to create and customize reward programs based on definable transaction details and without the financial institution having to obtain additional bank identification numbers, issue new payment cards to the deposit account holder or manually post the reward money to the intended recipient accounts. The present disclosure also provides the financial institution with a reporting system to which they can balance back to the accounting systems used in the financial processes.

The disclosure is a data processing system for monitoring, recording, and modifying information relating to financial institution issued cards and interchange fees, incomes, and rewards. The system and associated computer implemented method make the calculations necessary for assisting financial institutions in managing deposit account reward programs based on interchange fees and incomes with regard to specified transaction details. This is useful because there are such a large number and variety of transactions that financial institutions cannot maintain such programs due to lack of employee hours or the cost of implementing a transaction based reward program would be prohibitive. This system also help financial institutions become more competitive in the issued card market where the major card providers and their transaction reward programs make it more advantageous for the customer to use a credit card instead of the financial institution issued card tied to their deposit account. The system also helps financial institutions recover lost income due to the implementation of the Durbin Amendment that caps the amount of interchange income a financial institution can make on debit transactions. Finally, the system is useful for financial institutions and deposit account card holders as it helps retain customers by providing a viable way to incentivize and reward deposit account card holders for specific more lucrative transaction types.

According to various embodiments, the system allows a financial institution to create a reward program for signature based transaction types. When a deposit account card holder completes a transaction at a merchant or retailer, the card holder does so by signing the transaction receipt. In certain embodiments, the system collects the aforementioned transaction types related to a deposit account card holder, calculates the reward due, creates and delivers the necessary transaction file for the financial institution to post the reward, and generates the reports essential to reconcile the reward program's transactions with the financial institution's accounting system.

In certain embodiments, the system allows a financial institution to create a reward program for signature based transaction types that provide the monetary reward to an entity or multiple entities other than the deposit account card holder, such as, but not limited to, charities, businesses, or nonprofit organizations. The system collects the aforementioned transaction types related to a deposit account card holder's designated entity or entities, calculates the reward due to the entity or entities, creates and delivers the necessary transaction file for the financial institution to post the reward to the entity or entities, and generates the reports essential to reconcile the reward program's transactions with the financial institution's accounting system.

In certain embodiments, the system allows a financial institution to create a reward program for PIN based transaction types. When a deposit account card holder completes a transaction at a merchant or retailer, the card holder does so by entering their PIN. In some embodiments the system collects the aforementioned transaction types related to a deposit account card holder, calculates the reward due, creates and delivers the necessary transaction file for the financial institution to post the reward, and generate the reports essential to reconcile the reward program's transactions with the financial institution's accounting system.

In certain embodiments, the system allows a financial institution to create a reward program for signature or PIN based transaction types on only commercial deposit accounts. The system collects the aforementioned transaction types related to a commercial deposit account card holder, calculates the reward due, creates and delivers the necessary transaction file for the financial institution to post the reward, and generates the reports essential to reconcile the reward program's transactions with the financial institution's accounting system.

In certain embodiments, the system allows a financial institution to create a reward program for signature or PIN based transaction types on only consumer deposit accounts. The system collects the aforementioned transaction types related to a consumer deposit account card holder, calculates the reward due, creates and delivers the necessary transaction file for the financial institution to post the reward, and generates the reports essential to reconcile the reward program's transactions with the financial institution's accounting system.

In certain embodiments, the system, via online web interface or mobile application, allows a deposit account card holder to add, modify, or delete a reward recipient as their chosen reward recipient. Furthermore, the system allows the deposit account card holder to select multiple recipients based on multiple criteria, such as, but not limited to, reward limits, time frames, or percentage or dollar amount splits. In certain embodiments, the system collects the aforementioned transaction types related to a deposit account card holder, calculates the reward due, creates and delivers the necessary transaction file for the financial institution to post the reward, and generates the reports essential to reconcile the reward program's transactions with the financial institution's accounting system.

Among other things, it is the objective of the present disclosure to provide a means for creating transaction based reward programs that do not suffer from any of the problems or deficiencies associated with prior solutions.

Hereinafter, the present disclosure is described more fully with reference to the accompanying drawings, which are intended to be read in conjunction with both this summary, the detailed description and any preferred and/or particular embodiments specifically discussed or otherwise disclosed. This disclosure may, however, be embodied in many different forms and should not be construed as limited to the embodiments set forth herein. Instead, these embodiments are provided by way of illustration only and so that this disclosure is thorough, complete and fully convey the full scope of the disclosure to those skilled in the art.

The disclosure is directed to a system and a method to be used in connection to interchange fee income and card transactions and, more specifically, to the field of management and tracking of interchange fees, incomes and rewards associated with card transactions, and associated methods. The system and method according to the present disclosure is a computerized process for assisting financial institutions in managing deposit account reward programs based on interchange fees and incomes with regard to specified transaction details.

Data is collected and encrypted by retrieving information from a variety of sources relating to real world financial institutions, transactions, and deposit accounts. The financial institutions referenced here and throughout include banks and credit unions, but need not be limited to only banks and credit unions. Financial institutions are used throughout this disclosure as any entity that issues cards for conducting financial transactions.

Upon collecting and encrypting the deposit account, financial institution, and transaction information from a variety of sources the information is temporarily decrypted and the deposit account card holders, such as the users of the rewards system or customers of vendors, are assigned to the chosen or designated reward programs and the reward analysis and calculations may be applied in order to create the transaction or ACH file for the financial institution to provide the rewards to the appropriate recipients.

FIG. 1 illustrates an implementation 100 of an interchange fee income and reward system according to various embodiments of the present disclosure. The embodiment of the implementation 100 is for illustration only. Other embodiments could be used without departing from the scope of the present disclosure.

FIG. 1 illustrates an implementation 100 where the information 105 is collected, processed, encrypted and stored in the databases 110. In operation 115, the system utilized by the end users decrypts the data and creates and assigns shares of reward programs. In operation 120, the system analyzes and calculates the reward amounts that are written to a transaction or ACH file, in operation 125, for the financial institution to import and provide, in operation 130, the necessary reward money to the intended recipients. In operation 135, the system generates the reports essential for balancing the money transferred to the financial institution's accounting system. The imported files on FIG. 1 come from various sources, such as, but not limited to, the financial institution's core processing system, customer database, and card network providers. Different examples of the information 105 are an institution database 140, a shares database 145, a user's database 150, a transactions database 155, a customer database 160, a cards database 165, a share register 170, and ACH files 175. The information 105 contained in each file is discussed in further detail later in this disclosure. The institution database 140 includes details, such as, but not limited to, financial institution name, address, phone number, fax number, contact email addresses, routing number or numbers, website, deposit account data file import type, transaction file import type, core processing system, and ACH file format type. The user database 145 is setup by the financial institution program administrator and include information, such as, but not limited to, user name, user password, user first name, user last name, user access level, user email address, and user active indicator. The other databases shown are described in further detail later in this disclosure.

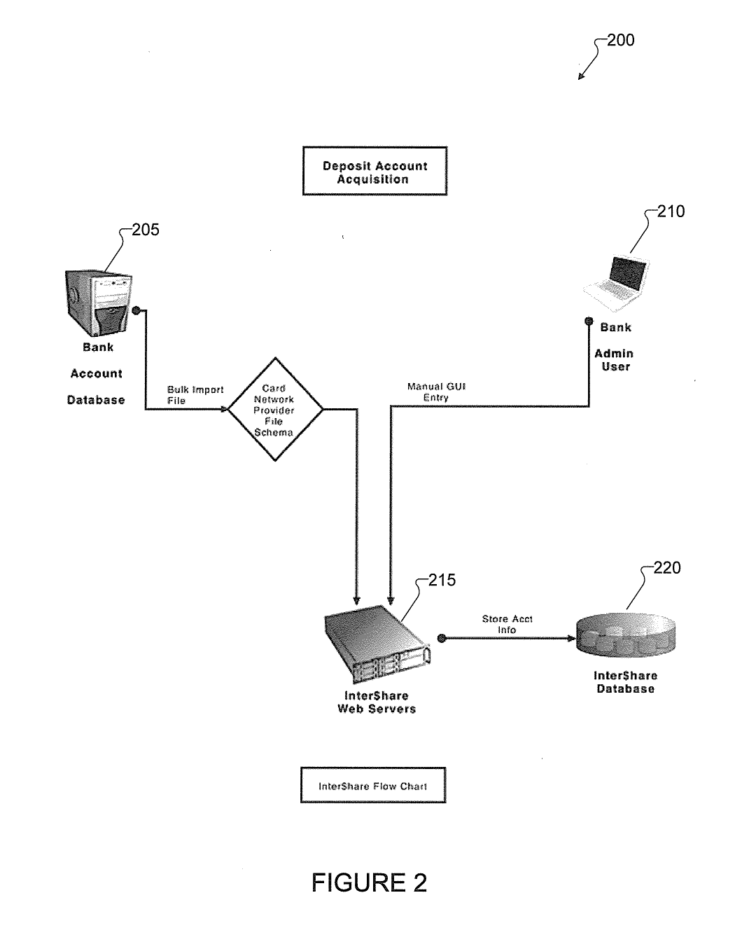

FIG. 2 illustrates an acquisition 200 of deposit account and deposit account holder's information according to various embodiments of the present disclosure.

FIG. 2 illustrates potential methods to capture deposit account information from a financial institution's deposit account database 205 or to use the system's user interface 210 for manually entering the deposit account information. The required information is collected or entered for a given deposit account is, but not limited to, the following: account number, account primary name, account secondary name, account primary address, account secondary address, account primary phone number, account secondary phone number, account primary email address, account secondary email address, account primary tax id number, account secondary tax id number, account primary date of birth, account secondary date of birth, account type (commercial or consumer), and account issued card numbers. Upon receiving the data file or manual entry through the user interface 210, the system 215 stores the required information in the proper databases 220 for later use by the system 215 and its associated methods.

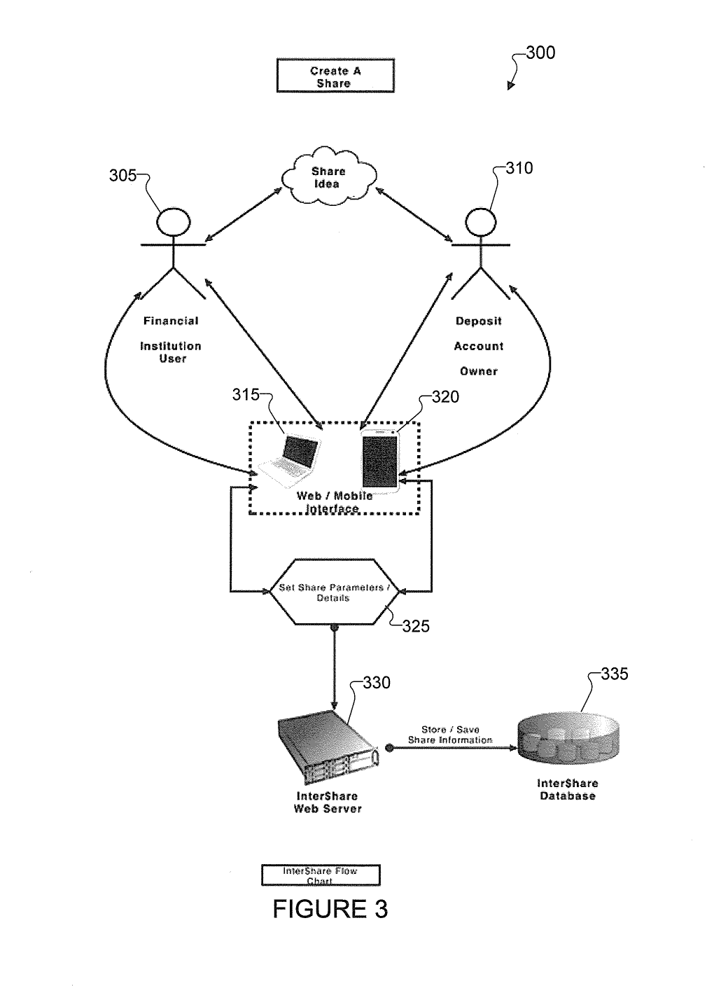

FIG. 3 illustrates creating a reward program according to various embodiments of the present disclosure.

FIG. 3 identifies various methods by which a reward program or “Share” is created by either the financial institution 305 or deposit account holder 310 through the system's web interface 315 or mobile application interface 320. The parameters 325 required by the system 330 include but are not limited to share name, account type (commercial or consumer), share beneficiary, beneficiary tax id number, beneficiary address, beneficiary phone number, beneficiary email address, beneficiary website, share basis (percentage of transaction or set dollar amount), share start date, share end date, share expiration date, share renewal date, share time span, share amount limit basis (percentage or set dollar amount), share limit, share transaction type (credit or debit), verification type (signature based or PIN based), and share aggregate limit. The share beneficiary is determined based on the depository financial institution (DFI) account number in an ACH file and the beneficiary tax id number is determined based on the identification number in the ACH file. The identification number in the ACH file corresponds to a social security number for an individual user and a taxpayer identification number for a company. Once the reward program or share parameters are entered into the system's interface, the system 330 processes and stores the necessary parameters and details in the appropriate databases 335 for future use by the system 330 and its associated methods.

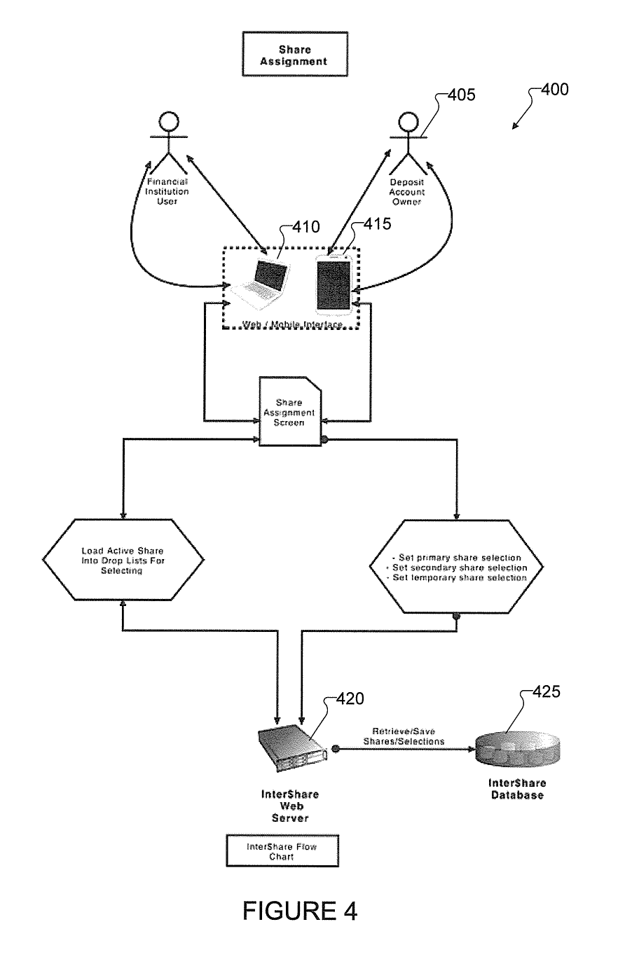

FIG. 4 illustrates methods for assignment or enrollment of a reward program according to various embodiments of the present disclosure.

FIG. 4 illustrates methods 400 for assigning or enrolling a deposit account holder 405 or owner in a share or multiple shares. The methods 400, such as, but not limited to, use the system's web interface 410 or utilize the mobile application interface 415 to assign or enroll a deposit account holder 405 in a share or reward program. The necessary information required to assign or enroll is, but not limited to, primary share selection, secondary share selection, temporary share selection, share primary start date, share secondary start date, share temporary start date, share primary end date, share secondary end date, share temporary end date, share primary reward percentage, share secondary reward percentage, share temporary reward percentage, share primary reward limit, share secondary reward limit, and share temporary reward limit. Once the share deposit account holder or owner has been assigned a share or enrolled in a share, the system 420 stores and encrypts the aforementioned share assignment parameters and details in the appropriate databases 425 for future use by the system 420 and its associated methods.

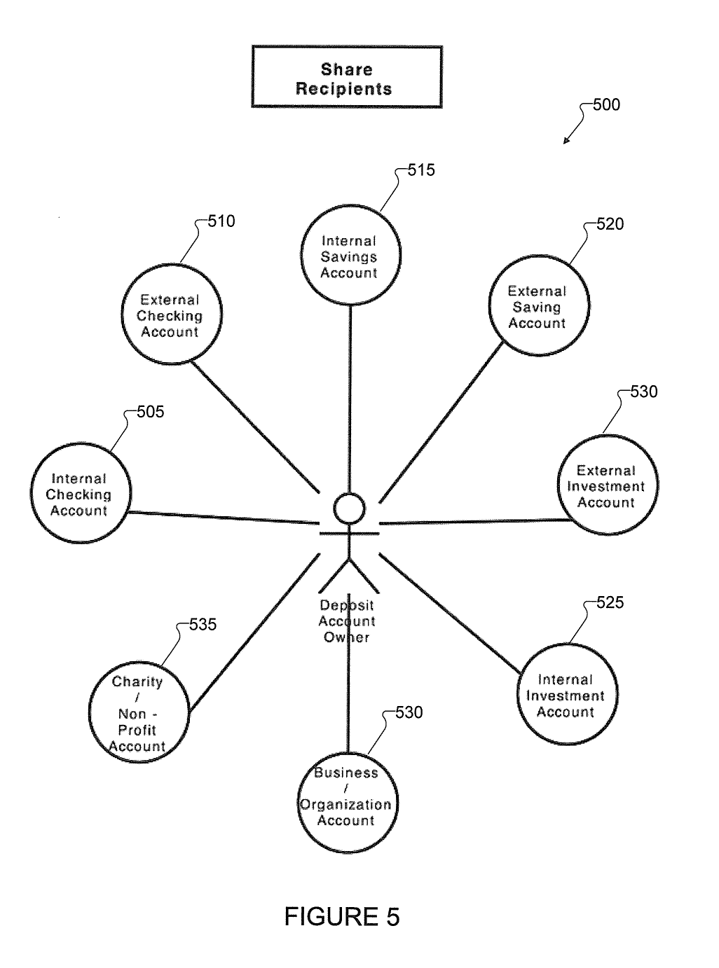

FIG. 5 illustrates potential reward recipients 500 according to various embodiments of the present disclosure.

FIG. 5 demonstrates the potential recipients 500 for reward money. As used herein recipients 500 can be referred to share beneficiaries. These recipients 500 may include, but are not limited to, checking account either self-owned or owned by another entity or individual and either internal 505 or external 510 of the financial institution administrating the reward program, savings account either self-owned or owned by another entity or individual and either internal 515 or external 520 of the financial institution administrating the reward program, investment or money market account either self-owned or owned by another entity or individual and either internal 525 or external 530 of the financial institution administrating the reward program, commercial account 530 either self-owned or owned by another entity or individual and either internal or external of the financial institution administrating the reward program, charity or nonprofit deposit account 535 either self-owned or owned by another entity or individual and either internal or external of the financial institution administrating the reward program. The share recipient is designated by the process shown in FIG. 3.

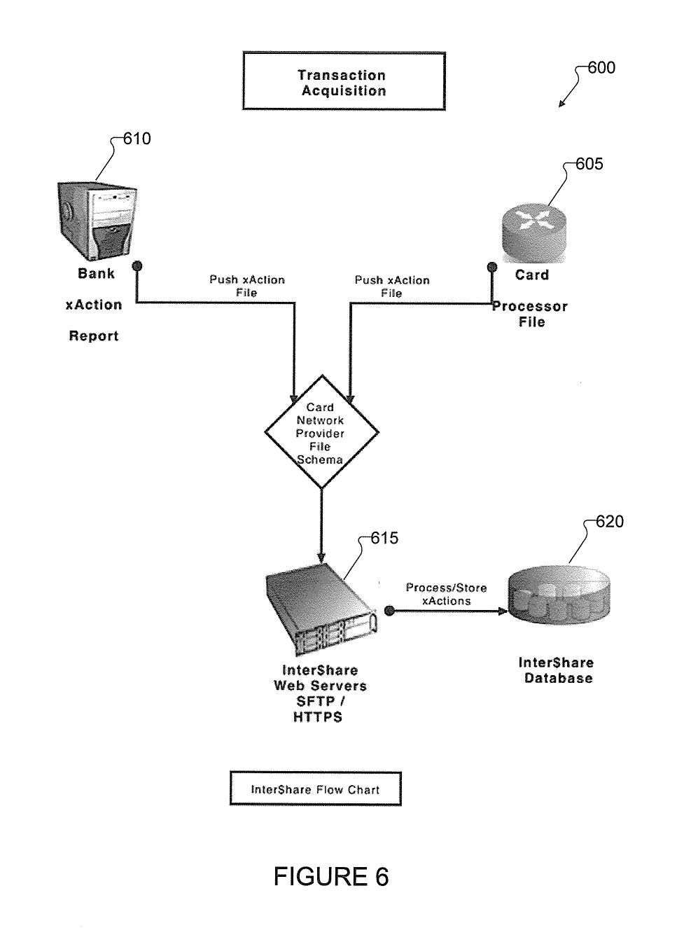

FIG. 6 illustrates acquisition 600 of card transaction information according to various embodiments of the present disclosure.

FIG. 6 demonstrates the methods for acquiring the transaction details of the card activity for a particular deposit account or numerous deposit accounts. The file 605 containing the transaction details is obtained from the following sources, such as, but not limited to, the financial institution's core processing system 610 or the card network provider's database. The transaction file 605 contains the following transaction details, such as, but not limited to, transaction date, transaction type (PIN or signature based), transaction card account number, transaction amount, transaction id, transaction owner or origination, and transaction authorization number. Utilizing the transaction file import type from the financial institution database shown in FIG. 1, the system 610 uses the correct import schema to process the transactions contained in the transaction file 605 and encrypts and stores the aforementioned transaction, which details in the transaction database 620 are also shown in FIG. 1. In certain embodiments, the transaction details are found in the ACH file. In an ACH file, the transaction type or verification type are found in the transaction code. The transaction code for demand credit is “22,” demand debit is “27,” savings credit is “32,” and savings debit is “37.” Additional transaction type or verification type details are found in the ACH addenda records and more specifically in the payment related information field. The payment related information field contains codes such as but not limited to “PUR DD” or “D CMP D” that identify additional details about the transaction or verification type. The codes contained in the payment related information field are defined by each ACH file originator and may differ from file to file. These transaction details are coded and stored in the system databases and then used by the system 610 to analyze and calculate the various share or reward amounts and any other disclosed associated methods within the system.

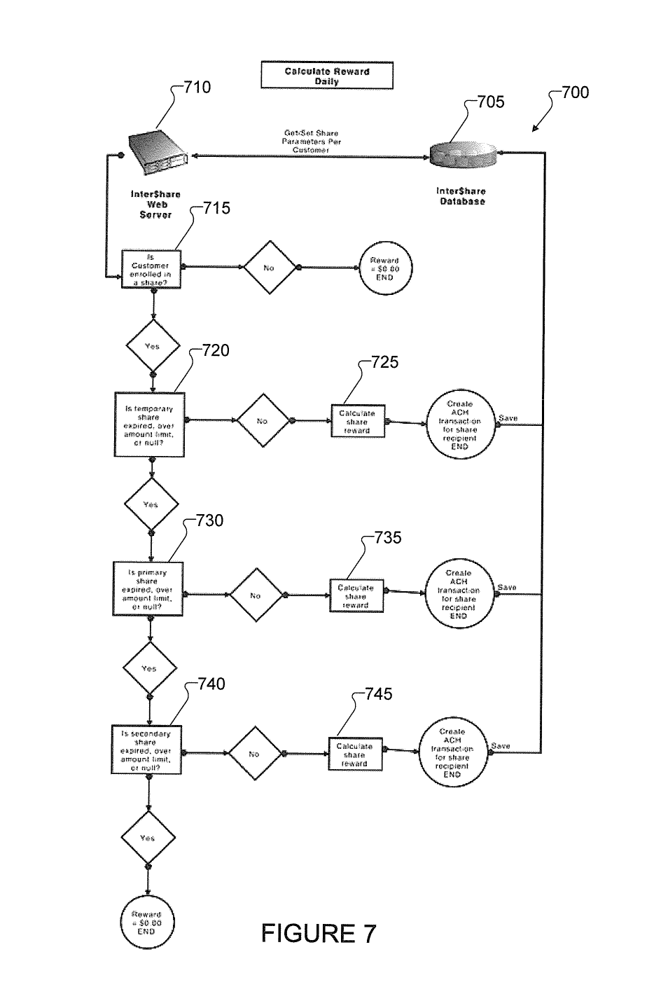

FIG. 7 illustrates a method 700 of analysis and calculation based on reward program parameters according to various embodiments of the present disclosure.

FIG. 7 visually describes the method 700 for determining the share or shares for which a deposit account holder is assigned. These methods described are for demonstration purposes and not to be construed as the only methods for determining assigned shares or calculating share rewards.

In operation 715, the system 710 receives the card processor file containing fixed length ASCII formatted raw transaction details for a POS transaction. The card processor file contains all the information received from the transaction, including the credit or debit card information and the information from the vendor. The system 710 using a decryption method matches the transaction details to deposit account information to identify a deposit account holder. Utilizing the decrypted information stored in the aforementioned databases 705 and shown in FIG. 1, in operation 720, the system 710 analyzes each deposit account holder and determines whether they are assigned to an eligible share program that precipitates a reward to disburse to the designated recipient.

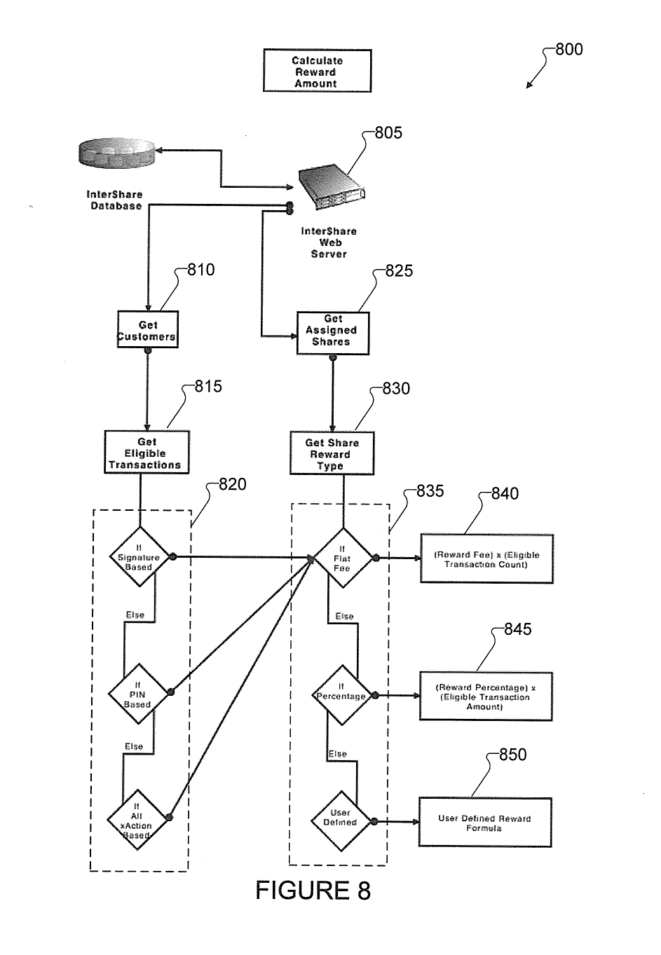

In operation 725, when a temporary share is selected, the system checks to see whether the temporary share has expired. When the temporary share has not expired, the system 710 determines whether the total amount of rewards has exceeded the temporary share limit. When the total amount of rewards has not exceeded the temporary share limit, then the system 710 determines whether the deposit account holder has qualifying transactions that fit the transaction requirements set forth by that share's parameters. In operation 730, when the transactions qualify, the system proceeds in calculating the reward amount shown in FIG. 8. When any of the checks fail, then the reward for the temporary share=$0.

In operation 735, when a primary share is selected, then the system checks to see whether the primary share has expired. When the primary share has not expired, the system checks to see whether the total amount of rewards has exceeded the primary share limit. When the total amount of rewards has not exceeded the primary share limit, then the system 710 determines whether the deposit account holder has qualifying transactions that fit the transaction requirements set forth by that share's parameters. In operation 740, when the transactions qualify, the system 710 proceeds in calculating the reward amount shown in FIG. 8. If any of the checks fail, then the reward for the primary share=$0.

In operation 745, when a secondary share is selected, the system 710 checks to see whether the secondary share has expired. When the secondary share has not expired, then the system checks to see if the total amount of rewards has exceeded the secondary share limit. When the total amount of rewards has not exceeded the secondary share limit, the system 710 determines whether the deposit account holder has qualifying transactions that fit the transaction requirements set forth by that share's parameters. In operation 750, when the transactions qualify, then the system proceeds in calculating the reward amount shown in FIG. 8. When any of the checks fail, then the reward for the secondary share=$0.

The share programs are not limited to just the three shares, e.g. primary, secondary, and temporary. The shares shown in FIG. 7 are for illustration purposes only and are not intended to be limiting. In certain embodiments, the system 710 assigns an unlimited number of shares to the deposit account holder or assigns all deposit accounts to one share without the ability to change the enrollment. The intentions of the shares is for the financial institutions to create an infinite amount of customized reward or share programs that fit an infinite set of requirements based on the financial institution's needs, business model, or market demands.

In operation 755, when any of the shares and transaction analysis returns a value greater than zero, the system creates an fixed length ACSII formatted ACH transaction file in accordance with the NACHA guidelines that designates the amount of money transferred to the intended recipient and stores and encrypts the necessary details of the transaction in the ACH database used in creating the ACH file imported by the financial institution.

FIG. 8 illustrates an analysis and calculation 800 of the reward amount based on reward program parameters according to various embodiments of the present disclosure. The rewards amount is the amount of rewards earned by the account holder through an eligible transaction. The rewards amount is received by the share recipient designated by the account holder.

FIG. 8 describes a sample calculation matrix to compute the reward amount for a given share and its corresponding transactions and set of parameters. After determining the validity of each share assigned to a deposit account and qualifying the transactions associated with it, the system 805 uses the custom defined formula to calculate the dollar reward amount to transfer to the intended recipient. For example, when the share parameters are set to only give rewards for signature based transactions and that reward is to be a percentage of the transaction amount, the system would multiply the defined percentage by the total eligible transaction amount to calculate the reward amount. (i.e., 1%×$4,500=$45.00). In certain embodiments, the system 805 rewards both signature based and PIN based transactions and bases the reward on a flat dollar amount for each eligible transaction. For example, when the deposit account holder had 50 eligible transactions and the reward dollar amount for each transaction was 0.05 then the total reward due the intended recipient is 50×0.05=$2.50. These examples are for illustration purposes only and not intended to be limiting or binding on the methods used to calculate the rewards for a given share. The intention of the disclosure is to give the financial institution an infinite or unlimited number of methods to calculate the rewards for each share. The reward for a particular share is determined by the transaction originator. For example, for each transaction at the local retail store the deposit account holder would receive a reward based on a formula determined by the financial institution.

In operation 810, the system 805 receives the deposit account information of the account holder. In operation 815, the system 805 receives the eligible transactions performed by the deposit holder. In operation 820, the system 805 determines the authorization or verification type, such as signature based, PIN based, or action based, for each eligible transaction found in the deposit account information of the account holder. In operation 825, the system 805 receives the assigned shares rules including the beneficiary of the rewards amount. In operation 830, the system 805 receives the share reward rules for each transaction type. In operation 835, the system 805 determines the method of payout, such as flat fee, percentage, or defined by the financial institution, for each eligible transaction based on the assigned share rules and the share reward rules. In operation 840, when the system 805 determines that the method of payout for the eligible transaction is a flat fee, the system 805 calculates the rewards amount for the beneficiary based on the flat fee. In operation 845, when the system 805 determines that the method of payout for the eligible transaction is a flat fee, the system 805 calculates the rewards amount for the beneficiary based on a percentage of the eligible transaction amount. In operation 850, when the system 805 determines that the method of payout for the eligible transaction is defined by the financial institution, the system 805 calculates the rewards amount for the beneficiary based on a custom formula.

In certain embodiments, the system defines the formula based on the verification type. When the verification type is a credit transaction, the reward amount is a fraction or percent of a credit card processing fee. When the verification type is a debit transaction, the reward amount is a fraction or percent of a debit card processing fee. In certain embodiments, different fraction or percentages are different based on the depository financial institution (DFI). The reward amount can vary based on the size of the DFI. The verification type is determined by using the transaction code in the ACH file and the DFI is determined based on the DFI identification number in the ACH file.

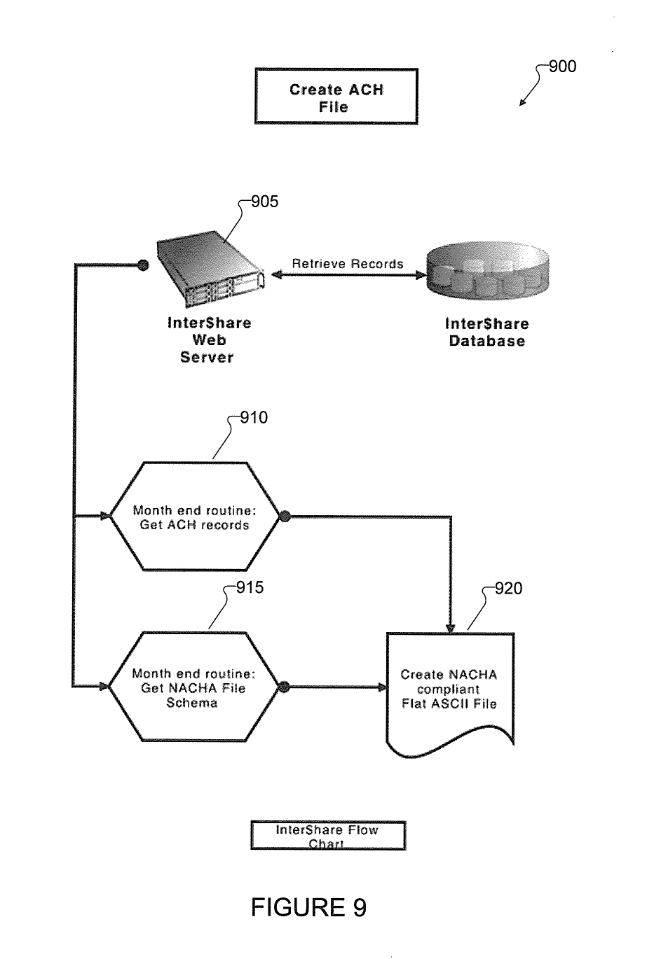

FIG. 9 illustrates creation 900 of the transaction or ACH file for posting reward amounts according to various embodiments of the present disclosure.

FIG. 9 displays the steps for creating the NACHA compliant ACH transaction file to be processed by the financial institution to transfer money to and from the intended accounts and recipients for the pre-calculated reward amounts. A predefined NACHA compliant file layout is used to format the ACH transactions that have been stored in the system's ACH database. This file is transmitted or downloaded by the financial institution each day so the money for the rewards is transferred and the financial institutions balances the reward transactions to their accounting systems.

In operation 910, the system 905 receives the ACH records including the month end routine. In operation 915, the system 905 receives the NACHA file schema including the month end routine. In operation 920, the system 905 creates a NACHA compliant flat ASCII File.

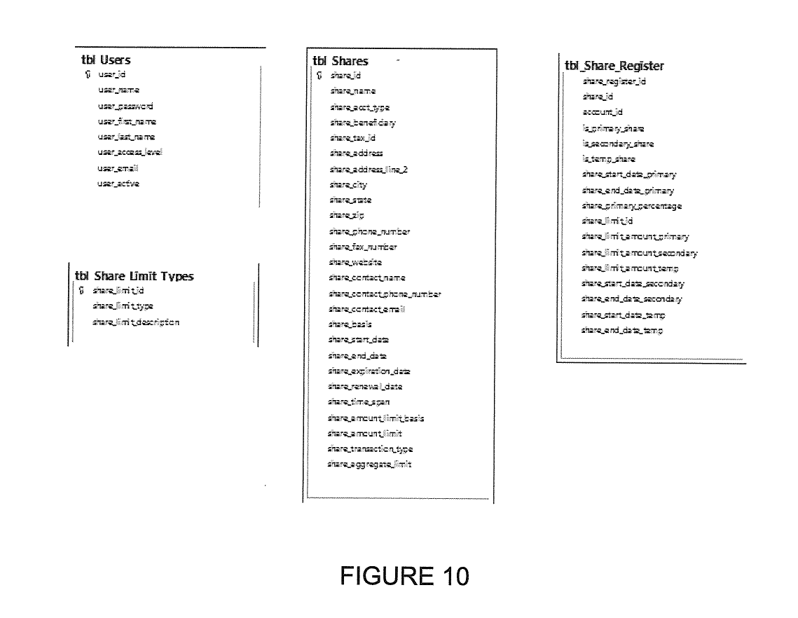

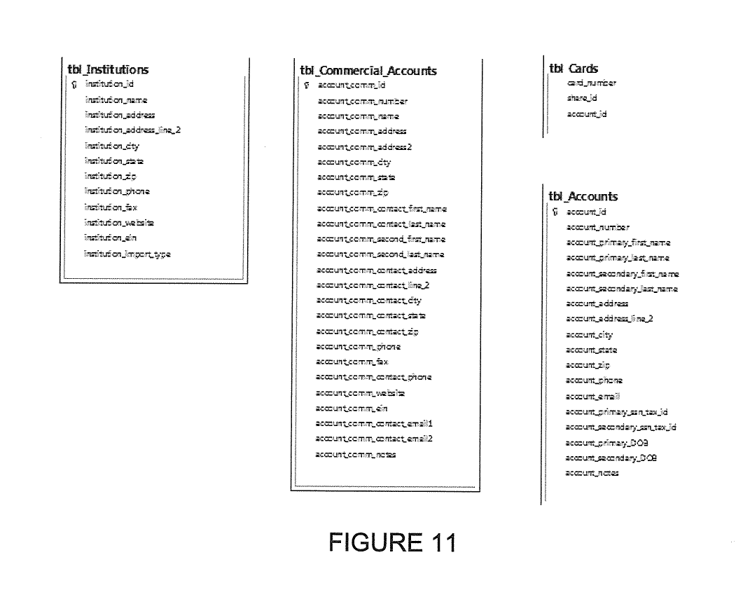

FIG. 10 and FIG. 11 illustrate potential database schema methods according to various embodiments of the present disclosure.

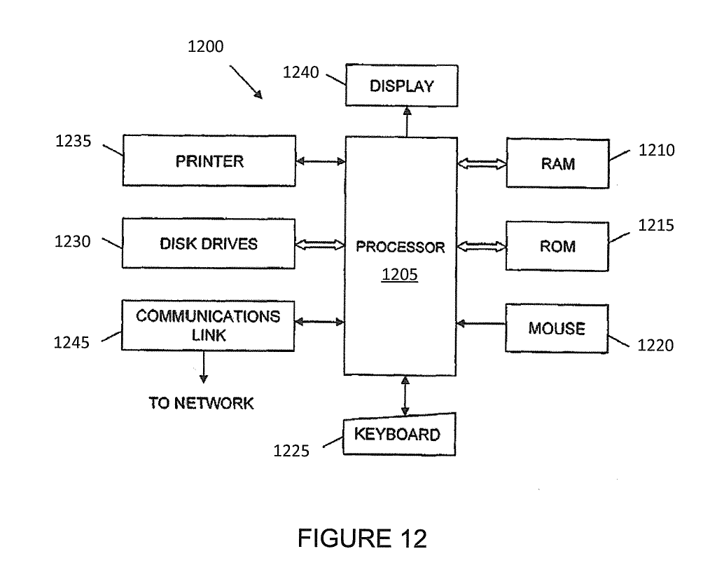

FIG. 12 illustrates an example computing device 1200 for n-level replication of supplemental content according to this disclosure. The computing device 1200 here could be used to implement any of the techniques or functions described above, including any combination of the techniques or functions described above. The computing device 1200 may generally be adapted to execute any of suitable operating system, including WINDOWS, MAC OS, UNIX, LINUX, OS2, IOS, ANDROID, or other operating systems.

As shown in FIG. 12, the computing device 1200 includes at least one processing device 1205, a random access memory (RAM) 1210, a read only memory (ROM) 1215, a mouse 1220, a keyboard 1225, and input/output devices such as a disc drive 1230, a printer 1235, a display 1240, and a communication link 1245. In other embodiments, the computing device 1200 may include more, less, or other components. Computing devices come in a wide variety of configurations, and FIG. 12 does not limit the scope of this disclosure to any particular computing device or type of computing device.

Program code may be stored in the RAM 1210, the ROM 1215 or the disc drive 1230 and may be executed by the at least one processing device 1205 in order to carry out the functions described above. The at least one processing device 1205 can be any type(s) of processing device(s), such as one or more processors, microprocessors, controllers, microcontrollers, multi-core processors, processing circuitry and the like. The communication link 1245 may be connected to a computer network or a variety of other communicative platforms, including any of the various types of communication networks 1240 described above. The disc drive 1230 may include a variety of types of storage media such as, for example, floppy drives, hard drives, CD drives, DVD drives, magnetic tape drives, or other suitable storage media. One or multiple disc drive 1230 may be used in the computing device 1200.

Note that while FIG. 12 provides one example embodiment of a computer that may be utilized with other embodiments of this disclosure, such other embodiments may utilize any suitable general-purpose or specific-purpose computing devices. Multiple computing devices having any suitable arrangement could also be used. Commonly, multiple computing devices are networked through the Internet or in a client-server network. However, this disclosure may use any suitable combination and arrangement of computing devices, including those in separate computer networks linked together by a private or public network.

The computing devices 1200 could represent fixed or mobile devices, and various components can be added or omitted based on the particular implementation of a computing device. For example, mobile devices could include features such as cameras, camcorders, GPS features, and antennas for wireless communications. Particular examples of such mobile devices include IPHONE, IPAD, and ANDROID-based devices.

The following definitions apply to certain words and phrases used throughout this patent document: the terms “include” and “comprise,” as well as derivatives thereof, mean inclusion without limitation; the term “or,” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. To the extent definitions for certain words and phrases are provided throughout this patent document, those of ordinary skill in the art should understand that in many, if not most, instances, such definitions apply to prior as well as future uses of such defined words and phrases.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for a blind reward system comprising:
receiving, at a server, a card processor file containing transaction details for a transaction, wherein the transaction details include a verification type;
matching the transaction details to deposit account information to identify a deposit account holder;
identifying a share beneficiary based on the deposit account information;
determining whether the verification type is a personal identification number (PIN) or a signature;
issuing a reward amount based on the verification type to the share beneficiary; and
creating a depository file designating the reward amount to the share beneficiary in a format that is importable by a depository financial institution (DFI).

2. The method of claim 1, wherein the card processor file and the depository file are ACH files.

3. The method of claim 2, wherein determining the verification type comprises determining a transaction code in the ACH file.

4. The method of claim 2, further comprising:
determining a depository financial institution (DFI) based on a DFI identification number in the ACH file; and
wherein issuing the reward amount is further based on the DFI identification number.

5. The method of claim 1, wherein the transaction details further comprises a share name, an account type, a share beneficiary, a beneficiary tax id number, a beneficiary address, a beneficiary phone number, a beneficiary email address, a beneficiary website, a share basis, a share start date, a share end date, a share expiration date, a share renewal date, a share time span, a share amount limit basis, a share limit, a share transaction type, and a share aggregate limit.

6. The method of claim 5, wherein the share beneficiary is determined based on the DFI account number in an ACH file, the beneficiary tax id number is determined based on the identification number in the ACH file.

7. The method of claim 6, wherein the identification number comprises a social security number for an individual user and a taxpayer identification number for a company.

8. A data processing system comprising:
a processor; and
an accessible memory, the data processing system particularly configured to:
receive a card processor file containing transaction details for a transaction, wherein the transaction details include a verification type;
match the transaction details to deposit account information to identify a deposit account holder;
identify a share beneficiary from the deposit account information;
determine whether the verification type is a personal identification number (PIN) or a signature;
issue a reward amount based on the verification type to the share beneficiary; and
create a transaction file designating the reward amount to the share beneficiary in a format that is importable by a financial institution.

9. The data processing system of claim 8, wherein the card processor file is an ACH file.

10. The data processing system of claim 9, wherein determining the verification type comprises determining a transaction code in the ACH file.

11. The data processing system of claim 9, further comprising:
determine a depository financial institution (DFI) based on a DFI identification number in the ACH file; and
wherein to issue the reward amount is further based on the DFI identification number.

12. The data processing system of claim 8, wherein the transaction details further comprises a share name, an account type, a share beneficiary, a beneficiary tax id number, a beneficiary address, a beneficiary phone number, a beneficiary email address, a beneficiary website, a share basis, a share start date, a share end date, a share expiration date, a share renewal date, a share time span, a share amount limit basis, a share limit, a share transaction type, and a share aggregate limit.

13. The data processing system of claim 12, wherein the share beneficiary is determined based on the DFI account number in an ACH file, the beneficiary tax id number is determined based on the identification number in the ACH file.

14. The data processing system of claim 13, wherein the identification number comprises a social security number for an individual user and a taxpayer identification number for a company.

15. A non-transitory computer-readable medium encoded with executable instructions that, when executed, cause one or more data processing systems to:
receive a card processor file containing transaction details for a transaction, wherein the transaction details include a verification type;
match the transaction details to deposit account information to identify a deposit account holder;
identify a share beneficiary from the deposit account information;
determine whether the verification type is a personal identification number (PIN) or a signature;
issue a reward amount based on the verification type to the share beneficiary; and
create a transaction file designating the reward amount to the share beneficiary in a format that is importable by a financial institution.

16. The non-transitory computer-readable medium of claim 15, wherein the card processor file is an ACH file.

17. The non-transitory computer-readable medium of claim 16, wherein to determine the verification type comprises determining a transaction code in the ACH file.

18. The non-transitory computer-readable medium of claim 16, further comprising:
determine a depository financial institution (DFI) based on a DFI identification number in the ACH file; and
wherein to issue the reward amount is further based on the DFI identification number.

19. The non-transitory computer-readable medium of claim 15, wherein the transaction details further comprises a share name, an account type, a share beneficiary, a beneficiary tax id number, a beneficiary address, a beneficiary phone number, a beneficiary email address, a beneficiary website, a share basis, a share start date, a share end date, a share expiration date, a share renewal date, a share time span, a share amount limit basis, a share limit, a share transaction type, and a share aggregate limit.

20. The non-transitory computer-readable medium of claim 19, wherein the share beneficiary is determined based on the DFI account number in an ACH file, the beneficiary tax id number is determined based on the identification number in the ACH file.
